(19) United States
(12) Patent Application Publication
(10) Pub. No.: US 2017/0243179 A1
(43) Pub. Date: Aug. 24, 2017

(54) SYSTEM AND METHOD TO MONETIZE DIGITAL ARTWORK

(71) Applicants: David Dehaeck, Antwerpen (BE); Nathalie Haveman, Antwerpen (BE)

(72) Inventors: David Dehaeck, Antwerpen (BE); Nathalie Haveman, Antwerpen (BE)

(21) Appl. No.: 15/228,392

(22) Filed: Aug. 4, 2016

Related U.S. Application Data
(60) Provisional application No. 62/299,508, filed on Feb. 24, 2016.

(51) Int. Cl. G06Q 20/10; H04L 29/06; G06F 3/0484; G06F 21/10

(52) U.S. Cl. CPC G06Q 20/102; G06F 21/10; H04L 63/08; G06F 3/0484; G06Q 50/184

(57) ABSTRACT

A system for monetizing a digital artwork. A patron edition system server provides a user interface through client devices which can be used for uploading a digital artwork to a data store by an artist or by a representative. The system generates a limited number of patron edition copies of the digital artwork as desired by the artist and enables transfer of ownership executable through the user interface for each patron edition copies. A sharing copy of the digital artwork is generated which is used for providing an Art-as-a-Service feature by streaming the sharing copy to client devices with temporary viewing rights in exchange of a fee from customers. The system facilitates sharing of the fee among a plurality of stakeholders. The limited number of patron edition copies makes the digital artwork exclusive whereas the Art-as-a-Service feature enables generation of a recurring income from the digital artwork.

### CROSS-REFERENCE TO RELATED APPLICATION

This application claims the benefit of U.S. Provisional Application No. 62/299,508, filed Feb. 24, 2016 the contents of which are incorporated herein by reference.

### FIELD OF THE INVENTION

The present invention in general is related to management of digital media artwork trading. More particularly, the present invention is related to a system and method for combining permanent viewing rights (ownership/possession) and temporary viewing rights (rental/loaning) for viewing digital artwork and allowing sharing of income from temporary viewing rights among the stakeholders.

### BACKGROUND OF THE INVENTION

Digital artwork or digital media artwork such as still images, animations and videos created by artist are reproducible like any other digital content. That implies, innumerable copies of a digital artwork, indistinguishable from the original artwork, can be reproduced. On the other hand, exclusivity and authenticity are the essence of an artwork. So, obviously, concern for these aspects affects the sale and distribution of digital artwork and, as a result, the digital artwork fails to reach a larger audience. There are open editions of digital artwork that lack exclusivity and, thus, hold very little financial value. Limited editions of artwork, on the other hand, are exclusive. But, again, lack of transparent sales channels and fear of piracy discourage potential buyers. And in case they do purchase a limited edition artwork, they hurriedly remove it from the public realm, basically rendering it invisible to the market and stifling its further value development. For these reasons, most of the digital artworks fail to realize their true market potential.

Thus, there is a need for a system and a method which facilitates increase of customer base for digital artworks while protecting the authenticity and exclusivity of the digital artworks.

### OBJECTS OF THE INVENTION

It is, therefore, an object of the present invention to provide a system and method for making digital artwork accessible to as many customers as possible without compromising on authenticity and exclusivity of the artworks.

Another object of the present invention is to provide a system and method for helping digital artworks realize their fullest market potential.

Yet another object of the present invention is to provide a system and method for monetizing digital artworks through granting of temporary viewing rights transmitted over a computer network.

Still another object of the present invention is to provide a system and method for maintaining records of chain of title for a digital artwork's ownership which ensures authenticity of the artwork.

A further object of the present invention is to provide a system and method which enable specifying maximum number of copies of a digital artwork that can be sold or distributed to ensure exclusivity of the digital artwork.

A still further object of the present invention is to provide a system and method for enabling earning of recurring income from temporary access (rent/loaning) of digital artwork and sharing of the earning among artist, collector etc.

Yet another object of the present invention is to provide a system and method for making all the relevant data related to trading history of an artwork available to users to make the process transparent.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system and method for creating an edition format that combines permanent viewing rights (ownership) and temporary viewing rights (rental) for monetizing editioned digital media art. This new edition format is hereinafter referred to as “Patron Edition” or as “patron edition”. The system that enables Patron Editions to work is hereinafter referred to as “Patron Edition System” or as “patron edition system”. Patron Edition System provides a platform for selling a predefined number of copies of a digital artwork by an artist or a representative of the artist to patrons/collectors and subsequent reselling of the copies of the artwork by the patrons/collectors. Examples of representative of the artist include, but are not limited to, a gallery, a dealer, an intermediary etc. The feature of allowing selling of only a limited number of copies of the digital artwork ensures exclusivity of the artwork. Also, the system records the chain of title in a blockchain based ledger for a digital artwork edition upon sale and/or a resale of the digital edition to ensure ownership authenticity of the digital artwork as an embedded part of the work. Further, the Patron Edition System allows streaming of a digital artwork over a computer network by the artist or a representative of the artist to subscribers of streaming services that enable viewing of the artwork on a client device on temporary basis for a specific period of time. The act of giving temporary viewing rights for a fee through streaming of a digital artwork for a specific period of time in accordance with an embodiment of the present invention is referred to hereinafter as “renting” of a digital artwork or as an “Art-as-a-Service”, both the terms being used alternatively and interchangeably. The system provides a secured environment for trading of digital artwork including loaning/renting of the artwork through encryption of the digital artworks, protection of copyright with invisible and online traceable watermarks, recording all activity as metadata of the work in a blockchain ledger, etc. The Patron Edition System also allows sharing among the stakeholders the revenue earned from permitting temporary viewing rights in the Art-as-a-Service activities and from permitting permanent viewing rights of the digital artworks i.e. from transfer of ownership of the artwork.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a general architecture of a patron edition system that operates in accordance with an embodiment of the present invention;

FIG. 2 illustrates a flowchart depicting the general steps associated with the method in accordance with an embodiment of the present invention;

FIG. 3 illustrates a non-limiting exemplary screenshot of Graphical User Interface (GUI) or user interface provided by the present invention for setting details of patron edition for a digital artwork in accordance with an embodiment of the present invention; and

FIG. 4 illustrates a non-limiting exemplary screenshot of the user interface showing the relevant information about patron editions of a digital artwork uploaded by an artist.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

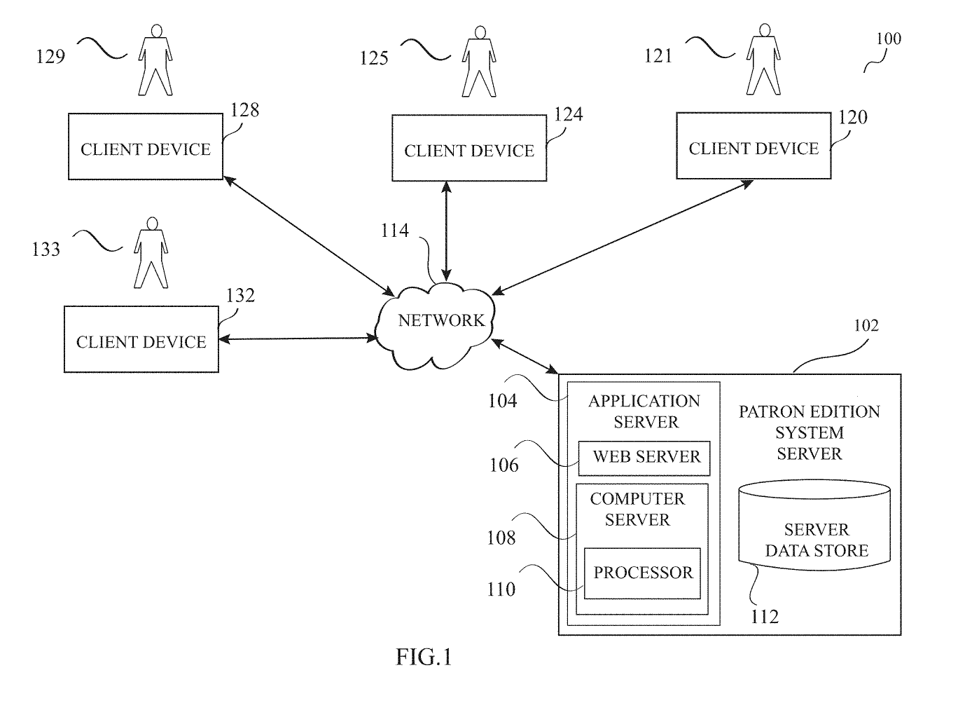

FIG. 1 illustrates the general architecture of a patron edition system 100 that operates in accordance with one embodiment of the present invention. Four numbers of computing devices or client devices 120, 124, 128 and 132 are shown connected to a patron edition system server 102 via a network 114. Although, only four computing devices or client devices are illustrated in FIG. 1, it is to be understood that there can be a plurality of client devices connected to the patron edition system server 102. The patron edition system server 102 communicates with the client devices over the network 114 to present a user interface for the patron edition system of the present invention. The user interface of the patron edition system of the present invention can be presented on the client device through a web browser or through a native mobile application communicating with the patron edition system server 102 and is used for displaying, entering and/or managing data. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 114 of FIG. 1 is for descriptive purposes only and it may be wired or wireless. Although, the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and future standards.

With respect to the present description, the patron edition system server 102 may include any service that relies on a database system that is accessible over a network, in which various elements of hardware and software of the database system may be shared by one or more users of the system 100. The graphical user interface (GUI) or user interface provided by the patron edition system server 102 on the client devices through a web browser or mobile app may be utilized by the users for signing up, logging in, adding digital artwork, selling and buying of digital artwork and streaming of digital artwork etc.

The components appearing in the patron edition system server 102 refer to an exemplary combination of those components that would need to be assembled to create the infrastructure in order to provide the tools and services contemplated by the present invention.

The patron edition system server 102 includes an application server or executing unit 104 and a data store 112. The application server or executing unit 104 comprises a web server 106 and a computer server 108 that serves as the application layer of the present invention. The computer server may comprise one or more processors 110. It would be obvious to any person skilled in the art that, although described herein as the data being stored in a single database, different separate databases can also store the various data and files of multiple users.

The Web server 106 is a system that sends out Web pages containing electronic data files in response to Hypertext Transfer Protocol (HTTP) requests from remote browsers (i.e. browsers installed in the client devices) or in response to similar requests made through a mobile app or mobile application of the present invention installed on a client device. The web server 106 can communicate with the mobile app of the present invention and/or with a web browser installed on a client device 120, 124, 128 and 132 to provide the user interface required for the patron edition system 100. Every client device comprise a processor (not shown in the figures) and this processor is configured to execute one or more instructions stored in a computer readable storage medium included in the client device.

Although, the description of the patron edition system server 102 may refer to terms commonly used in describing particular computer servers, the description and concepts equally apply to other processing systems, including systems having architectures dissimilar to that shown in FIG. 1.

The mobile application or “mobile app” is a computer program that may be downloaded and installed on client devices using methods known in the art. Hereinafter, the mobile app of the present invention is referred to as patron edition app. The patron edition app enables one or more users to do various tasks related to the patron edition system of the present invention. Examples of client devices 120, 124, 128 and 132 may include, but not limited to mobile devices, tablets, hand-held or laptop devices, smart phones, personal digital assistants, desktop computer or any similar computing devices.

The client devices may include various electronic components known in the art for this type of device. In this embodiment, the client devices may include a device display, a processor, user input device (e.g., touch screen, keyboard and/or other form of input device known in the art), a device transceiver for communication, a computer readable device memory and the patron edition app operably installed in the computer readable memory (not shown in figure). For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

An embodiment of the present invention will be described by way of a non-limitative example and with reference to the accompanying drawings. For example, reference to FIGS. 1, 2, 3 and 4, an artist has made one or more digital artworks, which the artist wants to monetize. The artist or his/her representative 121 can use his/her smartphone/laptop computer/desktop computer (i.e. a client device) 120 to access, as in step 204, the user interface provided by the patron edition system server 102 through a web browser or through the patron edition app installed on the client device 120 as in step 202. For becoming a registered user of the patron edition system it is necessary that the user provides some required information as in step 206. The patron edition system server 102 stores all the details of the users in the data store 112 as in step 208. After signing in, the registered artist or his/her representative 121 uploads the digital artwork to the patron edition system server 102 as in step 210. For authentication purpose the patron edition system may provide a transfer key to the user before uploading the digital artwork or, alternatively, the artwork can be authenticated after uploading the digital artwork file to the patron edition system server 102. The patron edition system server 102 associates the digital artwork with the artist 121 and stores the file in the data store 112 as in step 212 as a lossless archival copy, one or more patron edition copies and an exhibition copy/a web stream copy or a sharing copy. In some embodiments, a visible and/or an imperceptible digital watermark can be applied to a digital artwork making the digital artwork unique.

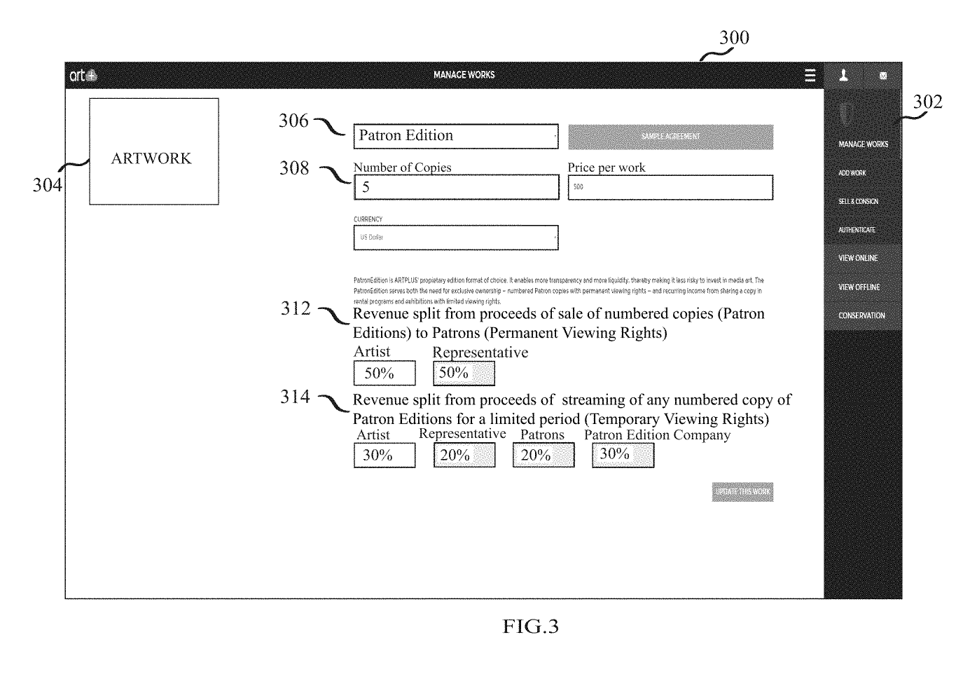

A registered user of the patron edition system 100 can sell, buy, exhibit, watch/view and rent out one or more digital artworks using the user interface provided by the patron edition system server 102. User-fillable objects/fields such as text fields, drop-down list boxes, radio buttons, and check boxes are provided on the user interface to set the specifics of the patron edition of the digital artwork as in step 214. These objects/fields are used for receiving data entered by the users and are preferably mapped to the data files associated with the digital artwork stored in the data store 112. FIG. 3 illustrates a non-limiting exemplary screenshot of Graphical User Interface (GUI) or user interface 300 provided by the present invention on the display of client device for setting the specifics of the digital artwork uploaded by the artist. In some embodiments, the GUI 300 can be presented by a client application such as a browser installed in the client device in communication with one or more servers hosting a web application/server application in accordance with an embodiment of the present invention. In FIG. 3, a panel 302 on the user interface 300 provides different tools related to the settings of patron editions for the digital artwork. A small image/icon 304 on the user interface represents the digital artwork for which patron edition settings are to be done. Patron edition system lets a user to make the digital artwork an open edition or a patron edition. As shown in FIG. 3, when the option patron edition is selected by the artist/representative 121 under the field 306, the patron edition system server 102 generates only those numbers of copies of the digital artwork which the artist 121 specifies under the field 308 on the user interface 300. In the present example, the maximum number of copies to be reproduced is 5 as indicated by the artist 121 in the field 308. So, for the artist/representative 121, the patron edition system server 102 will generate only 5 copies of the patron editions from the digital artwork uploaded by the artist. As shown in FIG. 3, the fields given under the heading 312 on the user interface 300 are for the artist/representative 121 through which the artist/representative can let the patron edition system know the way the revenue/earnings from the proceeds of patron edition digital artwork sale i.e. from sale of permanent viewing rights for the digital artwork to a patron/customer/collector is to be shared between the artist and his/her representative. In the present example the percentage share split is 50% for the artist and the rest 50% for the representative of the artist. In one embodiment, an artist user may grant temporary viewing rights (private view) to his/her representative(s) without charging any fee.

The patron edition system server 102 enables sending of video and/or audio content over the Internet which can be played immediately i.e. live on a client device without saving the content to the memory of the client device. This Art-as-a-Service feature provided by the present invention by streaming of video and/or audio contents of a sharing copy of the digital artwork makes it possible for the end users to play the media without actually downloading the file to a computer readable memory because the media is sent as a continuous stream of data. Example of streaming of digital artwork by the patron edition system server 102 includes, but is not limited to, Over-The-Top (OTT) streaming. In the field of content delivery, Over-The-Top (OTT) content refers to online delivery of video and audio content without the service provider being actively involved in the control or distribution of the content itself. The Internet service provider, for example, may be aware that content is being consumed, but it is not responsible for, nor able to control, the viewing abilities, copyrights, or redistribution of the content. This is in contrast to content delivery through purchase or rental from an IPTV provider, a cable television operator, or the Internet service provider itself. Consumers can access OTT delivered digital artwork through a client device. In one embodiment the patron edition system supports a multicast streaming of the digital artwork so that multiple users can access to the same content simultaneously. In some embodiments, streaming of sharing copy of patron edition digital artwork can be offered through television channels via third party OTT streaming services as well as through set top boxes. Streaming of the sharing copy of patron editions of the digital artwork to multiple customers who may be interested only in viewing/watching the artwork i.e. in availing Art-as-a-Service without becoming owners of the artwork enhances the accessibility of the digital artwork by a larger number of customers than it would have been possible had the digital artwork been made accessible only as a limited edition as is envisioned by the prior art systems in case of digital artworks to preserve exclusivity. Thus, the patron edition is not similar to the existing limited edition versions. Rather, patron edition can be termed as a hybrid edition of a limited edition and Video On Demand rent service (Art-as-a-Service), because, despite of making only a limited number of copies of a digital artwork available to owners who want permanent viewing rights, the sharing copy of the limited number of digital artwork editions can be made available to innumerable customers by renting out temporary viewing rights for the digital artwork for a specific time period (i.e. Art-as-a-Service). A fee may be charged from the customers accessing the digital artworks of the patron editions from the patron edition system server for the Art-as-a-Service or digital artwork rental service. The streaming of the patron editions of digital artwork for a fee as proposed by the present invention opens up the door for generating recurring earnings from a limited edition of a digital artwork for the artist, artist's representatives and the gallery hosting the artwork without compromising on the exclusivity and authenticity of the digital artwork. The user interface of the present invention allows the artist or the representative of the artist to define the way earnings are to be shared among the different stakeholders when a sharing copy of a patron edition digital artwork is rented out to one or more customers for viewing/watching the artwork on temporary basis. As shown in FIG. 3, the fields under the heading 314 on the user interface 300 can be used by the artist/representative 121 to indicate the way revenue earned from streaming of patron edition digital artwork is to be split among the stakeholders i.e. among the artist, artist's representative, patrons and the patron edition company that operates the patron edition system server or third party service providers that provide access to the Sharing Copy via embedded API's on their platforms. Once the details for the patron editions are entered through the user interface, the patron editions of the digital artwork are made available for users of the system by the patron edition system server 102 as in step 216.

Any customer/patron who wants to buy (transfer of ownership) a digital artwork or who wants to watch/view the digital artwork uploaded by the artists/representatives on the basis of owning permanent viewing rights or temporary viewing rights has to become a registered user of the patron edition system 100. In the present example it is assumed that individuals 125 and 129 (refer FIG. 1) are two customers who are interested in buying permanent viewing rights i.e. transfer of ownership of a digital artwork uploaded to the patron edition system 100 by an artist or by artist's representative. Hereinafter, customers 125 and 129 are referred to as Patron 1 and Patron 2 respectively. Patron 1 can access the user interface provided by the present invention as in step 218 on a client device 124 and sign up with the patron edition system as in step 220. If Patron 1 likes the digital artwork uploaded by the artist/representative 121 then he/she can send a request to the artist/representative 121 for transfer of ownership of the digital artwork as in step 222. On receiving the request the artist may initiate the process for transfer of ownership for the digital artwork through the user interface as in step 224.

For making the transfer of ownership of a patron edition digital artwork secured, in a preferred embodiment, the patron edition system server 102 provides a multi-tier authentication method. The patron edition system also facilitates, as in step 226, in executing the other relevant steps for transferring the ownership of the digital artwork such as signing of a contract, transfer of funds etc. After executing these steps, in the present example, Patron 1, as in step 228, becomes the owner of one of the 5 copies with permanent viewing rights of the patron editions. Being the first owner of any of the numbered copy of patron edition copies, Patron 1 can be termed as the founding patron for the digital artwork. Subsequently, Patron 1 now has the option of retaining the digital artwork as a collector or selling the patron edition digital artwork to another user. Although, patrons are allowed to resell the patron edition copies owned by them, to protect the integrity of the work, the Patron Edition system does not allow the patrons to rent out any copy of the patron edition. The only parties who decide when and where a Sharing Copy of an edition will be presented as Art-as-a-Service in return for fees are the Artist and/or the authorized representative of the Artist.

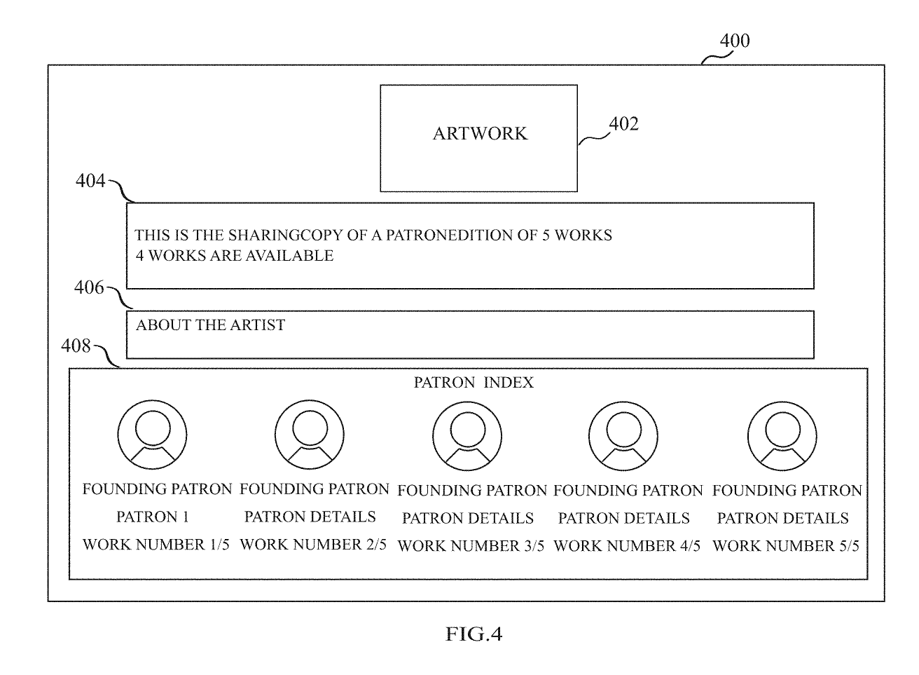

Patron 2 can access the user interface provided by the present invention as in step 230 on a client device 128 and sign up with the patron edition system as in step 232. In the present example, since Patron 1 is now an owner of a patron edition copy of the digital artwork, Patron 2 may approach Patron 1 for buying the copy of the patron edition digital artwork from Patron 1. Alternatively, Patron 2 can also approach artist/representative 121 for transfer of ownership of a copy of the patron edition digital artwork if any copy is left unsold with the artist/representative as in step 234. A user visiting the user interface may find all such relevant information there. For example, user interface 400 of FIG. 4 shows, in a window 402, an artwork uploaded by an artist to the patron edition system server 102 and some relevant information related to the artwork shown in window 402. The information may include information on the total number of patron edition copies made and the total number of patron edition copies available for sale as shown within box 404. Further, the information may also include information on the artist as shown within box 406. To make trading of a digital artwork through the patron edition system transparent and to facilitate verification of provenance data associated with the digital artwork, the present invention provides on the user interface a record of ownership of the patron edition copies of the digital artwork, the record being hereinafter referred to as Patron Index. The Patron Index, as shown within the box 408 on the user interface 400, includes information, among others, information on the patrons who buy permanent viewing rights of the digital artwork and the unique numbers of the patron edition copies owned by the patrons etc. In a preferred embodiment, the first buyers of the patron edition copies in the primary market are referred to as Founding Patrons. In the secondary market, whenever a Founding Patron sells a digital artwork through the system, then the new owners will be listed in the Patron Index as Active Patrons. The sellers from the primary market will be listed under their respective headings in the provenance as Past Founding Patrons. Similarly, in the secondary market, sellers will be listed as Past Patrons in the Patron Index. In the present example, Patron 1 is one of the Founding Patrons for the digital artwork. If Patron 2 buys the digital artwork from the artist then Patron 2 becomes a Founding Patron and, if Patron 2 buys it from Patron 1, then Patron 2 becomes an Active Patron and Patron 1 becomes a Past Founding Patron for the patron edition copy of the digital artwork being traded. Be it from the primary market or from the secondary market, at any given point of time the present owners of the patron edition copies will be collectively referred to hereinafter as “current patrons”.

Accordingly, Patron 2 can either become one of the Founding Patrons for the digital artwork if Patron 2 can manage to buy a patron edition copy from the artist or he/she can become an Active Patron if he/she can manage to buy a copy from one of the Founding Patrons, as in step 236. In the secondary market, through the patron edition system, Patron 2 can subsequently sell the artwork to another customer and, in that, case Patron 2 will be indicated in the Patron Index as a Past Patron. Thus, as explained above, for all the transfers of ownership happening to a copy of the patron edition digital artwork upon sale and/or a resale of the digital artwork, the patron edition system server 102 maintains a chain of title so that authenticity of the copy of the artwork can be ascertained by any concerned party through the user interface. Additionally, the patron edition system server 102 also keeps record of all relevant information about the patron editions and makes this information accessible to other users of the system (as Patron Index, for example). This makes the system transparent and allows users to see who owns what, what prices are, how many times works have been resold, and which art works are most lucrative. This can boost sales and stimulate a secondary market.

In a preferred embodiment, blockchain technology is used for recording the chain of titles which creates a chain where any changes made to a block will change that block's hash, which must be recomputed and stored in the next block.

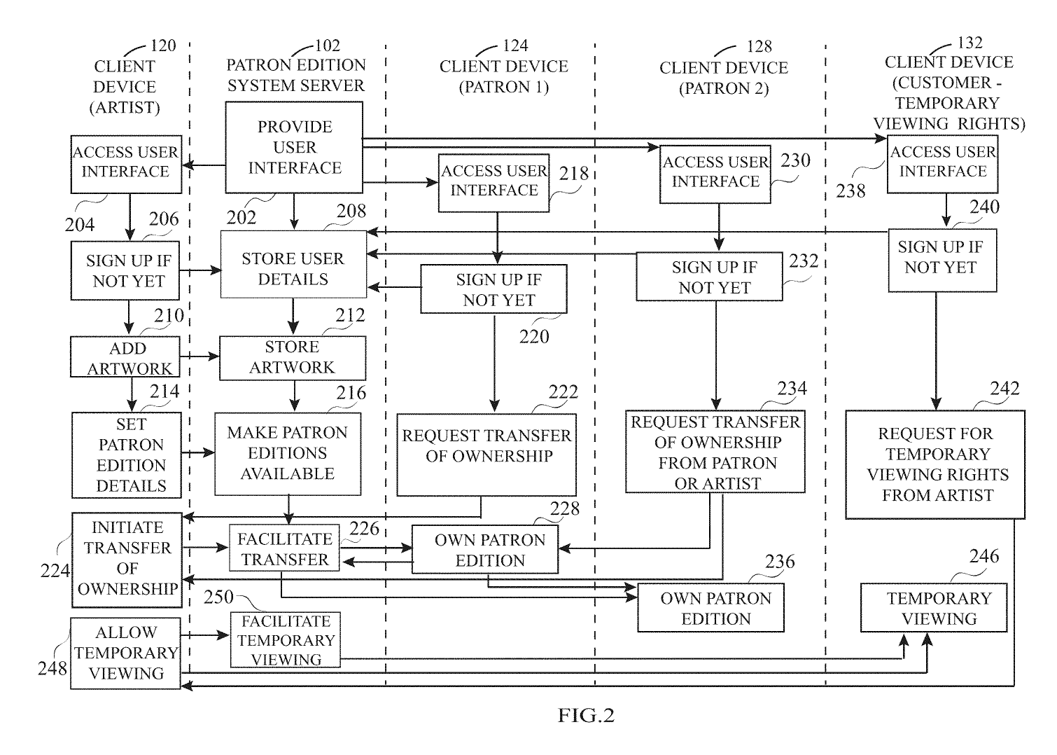

Continuing with the present example, a person 133 is a customer who wants to watch/view the digital artwork uploaded by the artist/representative 121 to the patron edition system on a temporary basis without owning the artwork. For this, customer 133 has to access the user interface provided by the present invention, as in step 238, on a client device 132 and sign up with the patron edition system as in step 240. The customer 133 can now request the artist, as in step 242 of FIG. 2, for availing the Art-as-a-Service feature of the present invention which can provide temporary viewing rights to the customer for the digital artwork. Accordingly, for a certain fee, the artist may let the customer enjoy the sharing copy of the digital artwork on a client device for a specific period of time as in step 248. As discussed above, the patron edition system server 102 facilitates, as in step 250, viewing/watching of the digital artwork by the customer 133 by streaming the content of the digital artwork on the client device 132. The customer 133 can enjoy the digital artwork on the client device 133, as in step 246, for the specific period of time for which a fee has been paid.

In a preferred embodiment, the patron edition system 100 provides unique cryptographic Certificates of Authenticity with QR code link to guarantee provenance.

While the present invention is susceptible to various modifications and alternative designs, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “affixed”, “fitted” are to be construed as partly or wholly contained within, attached to, or joined together, even if there is something intervening. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The flowchart is used to describe the steps of the present invention. While the various steps in the flowchart are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIG. 2 should not be construed as limiting the scope of the invention

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for monetizing a digital artwork, the system comprising:
one or more client devices; and
at least one patron edition system server communicatively connected to said one or more client devices through a network, said at least one patron edition system server having one or more data stores and one or more processors, said at least one patron edition system server is operable to, at least;
provide a user interface through said one or more client devices;
enable uploading of said digital artwork to said one or more data stores by an artist or by a representative of said artist using said user interface;
generate a limited number of patron edition copies from said digital artwork stored in said one or more data stores as desired by said artist, a transfer of ownership being executable through said user interface for each copy of said limited number of patron edition copies;
generate a sharing copy of said digital artwork stored in said one or more data stores, said sharing copy being used for providing an Art-as-a-Service feature by streaming said sharing copy of said digital artwork over said network to said one or more client devices with temporary viewing rights in exchange of a fee from one or more customers;
facilitate sharing of said fee among a plurality of stakeholders;
wherein, said limited number of patron edition copies make said digital artwork exclusive whereas said Art-as-a-Service feature enables generation of a recurring income from said digital artwork.

2. The system as in claim 1, wherein for every said transfer of ownership a record of a chain of title for said each copy of said limited number of patron edition copies is maintained in a blockchain based ledger to provide provenance information.

3. The system as in claim 1, wherein only said artist or said representative is authorized to enable said Art-as-a-Service feature.

4. The system as in claim 1, wherein said plurality of stakeholders include said artist, said representative, one or more current patrons and a company providing said system for monetizing said digital artwork.

5. The system as in claim 1, wherein each of said limited number of patron edition copies is identifiable by an edition number that uniquely identifies each of said limited number of patron edition copies.

6. The system as in claim 1, wherein said Art-as-a-Service feature provided by streaming said sharing copy of said digital artwork over said network to said one or more client devices is done for a limited period of time defined by said artist.

7. The system as in claim 1, wherein said transfer of ownership of each copy of said limited number of patron edition copies involves a multi-tier authentication method.

8. A method for monetizing a digital artwork in a patron edition system, said patron edition system comprising one or more client devices and at least one patron edition system server communicatively connected to said one or more client devices through a network, said at least one patron edition system server having one or more data stores and one or more processors, said method comprising the steps of:
presenting a user interface through said one or more client devices by said at least one patron edition system server;
enabling uploading of said digital artwork to said one or more data stores by an artist or by a representative of said artist using said user interface;
generating a limited number of patron edition copies from said digital artwork stored in said one or more data stores as desired by said artist, a transfer of ownership being executable through said user interface for each copy of said limited number of patron edition copies;
generating a sharing copy of said digital artwork stored in said one or more data stores, said sharing copy being used for providing an Art-as-a-Service feature by streaming said sharing copy of said digital artwork over said network to said one or more client devices with temporary viewing rights in exchange of a fee from one or more customers; and
facilitate sharing of said fee among a plurality of stakeholders;
wherein, said limited number of patron edition copies make said digital artwork exclusive whereas said Art-as-a-Service feature enables generation of a recurring income from said digital artwork.

9. The method as in claim 8, wherein for every said transfer of ownership a record of a chain of title for said each copy of said limited number of patron edition copies is maintained in a blockchain based ledger to provide provenance information.

10. The method as in claim 8, wherein only said artist or said representative is authorized to enable said Art-as-a-Service feature.

11. The method as in claim 8, wherein said plurality of stakeholders include said artist, said representative, one or more current patrons and a company providing said system for monetizing said digital artwork.

12. The method as in claim 8, wherein each of said limited number of patron edition copies is identifiable by an edition number that uniquely identifies each of said limited number of patron edition copies.

13. The method as in claim 8, wherein said Art-as-a-Service feature provided by streaming said sharing copy of said digital artwork over said network to said one or more client devices is done for a limited period of time defined by said artist.

14. The method as in claim 8, wherein said transfer of ownership of each copy of said limited number of patron edition copies involves a multi-tier authentication method.
